(19) United States
(12) Patent Application Publication
(10) Pub. No.: US 2009/0313380 A1
(43) Pub. Date: Dec. 17, 2009

(54) DISTRIBUTION SYSTEM

(76) Inventor: Hiroshi Kurihara, Kawasaki (JP)

Correspondence Address: MATTINGLY & MALUR, P.C., 1800 DIAGONAL ROAD, SUITE 370, ALEXANDRIA, VA, 22314, US

(21) Appl. No.: 12/368,405

(22) Filed: Feb. 10, 2009

(30) Foreign Application Priority Data
Jun. 11, 2008 (JP) 2008-153004

(51) Int. Cl. G06F 15/16

(52) U.S. Cl. 709/230

(57) ABSTRACT

The present invention promotes the use of contents distribution by multicast, and enables users to stop viewing without needing special processing in a terminal, and to restart viewing in the same terminal as that at stop time or a different terminal, thus increasing users' usability and use opportunities. In a distribution system including a service server, a multicast distribution server, and a unicast distribution server, the service server, in a first access from a PC, selects the multicast distribution server as a distribution server, and selects the unicast distribution server as a distribution server after stopping.

### CLAIM OF PRIORITY

The present application claims priority from Japanese patent application serial no. 2008-153004, filed on Jun. 11, 2008, the content of which is hereby incorporated by reference into this application.

### BACKGROUND OF THE INVENTION

The present invention relates to a distribution system, and more particularly to a distribution system that switches between multicast distribution and unicast distribution.

Communication technologies such as multicast and unicast in communication networks exist in IPv4 and IPv6 (Internet protocol) as well-known, and usually are used in the Internet, local area network (LAN), and the like.

Using these communication technologies, a variety of IP-based services by the Internet are widely used and recognized. One of the services is video on demand (VOD) service that distributes moving video contents, music contents, and the both contents (hereinafter referred to as contents) to terminals. The VOD service is expected to become more widespread as one of services in a Next Generation Network (NGN). As for IP-based contents distribution, recently, there are Internet Protocol TeleVision (IPTV) and the like studied in the International Telecommunication Union Telecommunication standardization sector (ITU-T), which is an international standardization organization, and the like.

For viewing of video and voice contents, there are various methods or technologies on trick plays such as pause, restart from pause, forward, and rewind. The methods or technologies are achieved by providing features for both a center system that delivers the contents, and terminals that receive them, providing features for only the terminals, or providing features for the center system. For example, contents themselves for trick plays are provided separately from their original contents, and when a request for trick play is issued from a terminal, the original contents are displayed and viewed in place of the contents for trick plays. This is one method for achieving trick plays, which provides features for the center system.

Documents below are publicly known as such contents distribution methods or distribution systems for achieving particularly stop and restart.

The following distribution system is disclosed in JP-A No. 244955/2002. The distribution system receives a stop indication for contents distribution from a terminal, (1) stops contents distribution, (2) stores a stop position, and (3) in some cases, issues a password for restart to the terminal, and on subsequently receiving a restart request from the terminal, restarts contents distribution from the stop position. A terminal at restart may be different from one at stop time.

JP-A No. 174636/2003 discloses a method of achieving the stopping and restarting of viewing by a playing device and a distribution device (service server). A terminal (playing device), during stopping of playing, produces user information containing a time point indicating at least a play stop position, and transmits it to a distribution system (distribution device). The received user information is managed in the distribution system (distribution device), which during restarting of playing, based on the time point indicating a restart stop position within the user information, restarts contents distribution from near the stop position.

JP-A No. 189276/2003 discloses a method for enabling the stopping and restarting of viewing by a contents playing device (user terminal) and a server device. The method in JP-A No. 189276/2003, rather than stopping and restarting, appends time marks to a video in arbitrary timing in the course of viewing so that contents can be distributed and played from any appended time marks. By appending a time mark also during stopping, the same approach can be taken for stopping and restarting. The terminal (contents playing device) requests the distribution system (server device) to append time marks, and the appended time marks are managed in the distribution system (server device). For a play or restart request from the terminal (contents playing device), the terminal receives information containing time marks appended previously by the user from the distribution system (server device), and the user selects a time mark such as a stop position so that continued contents can be restarted from near the selected time mark.

Particularly, according to the description of an embodiment of JP-A No. 189276/2003, when requesting the distribution system (server device) to record time marks, the terminal (contents playing device) transmits time axis position information (elapsed time) from a play start position of contents data to the distribution system (server device), which manages it and provides it to the terminal (contents playing device) when playing is requested. The time mark setting request containing the time axis position information of JP-A No. 189276/2003 is also like the user information containing time points indicating play stop positions of the terminal (playing device) in JP-A No. 174636/2003; information identifying so-called stop positions is transmitted from a terminal to the distribution system, which manages it.

Time axis position information (elapsed time) from a play restart position according to the description of the embodiment of JP-A No. 189276/2003, and user information containing time points indicating play stop positions according to JP-A No. 174636/2003 are transmitted to the distribution systems from terminals, respectively. However, in terms of increasing users' usability and use opportunities, it is preferable to achieve stopping in common terminals without needing special operations in a terminal even for such processing. The common terminals referred to here are terminals such as personal computers (PC) and personal digital assistants (PDA) that come standard with generally available browsers, mailers, contents player software, and the like.

In JP-A No. 244955/2002, on receiving a stop indication, the distribution system stops contents distribution. In multicast distribution, usually, a large number of users and a large number of terminals receive identical contents. Therefore, distribution by multicast use leads to efficient use of communication networks. In this case, however, even when a stop indication is issued from a specific terminal, the distribution system cannot stop contents distribution as long as other users or other terminals receive.

Contents distribution services such as VOD service have come into widespread use, and are widely recognized and being used by users. In the VOD service, the use of contents distribution by multicast is important as communication networks because of the limit of transmission capacity. Furthermore, because of the universal psychology of users who demand the viewing of contents of high quality, high sound quality, multilingual, and the like, high-capacity contents distribution occupying high bands at least temporarily is expected to swing into full gear. Because of these facts, contents distribution by multicast use is highly expected.

On the other hand, users pursue usability. There are high user needs for functions of existing recorders and players such as stop and restart or provided services, particularly for contents requiring several hours such as general movies, recorded sports, and long dramas. Moreover, it goes without saying that playing contents cannot be stopped just for a specific person's desire in a movie theater. However, the circumstances could be a little different in a private relaxing space such as a living room. There are universally various use situations such as stopping, then restarting viewing, or stopping viewing, then restarting viewing during moving in a visiting place after going out, and users' usability and use opportunities increase more and more. An example of viewing forms is to stop a movie viewed by a fixed terminal such as TV and PC in a living room and view its continuation within a vehicle (mobile terminal).

### SUMMARY OF THE INVENTION

The present invention has been made in view of such circumstances. That is, by a method or a distribution system that distributes contents such as movies and sounds through networks, the use of multicast-based contents distribution that contributes to efficient use of the communication networks is prompted. Furthermore, the present invention provides a contents distribution system that aims at increasing users' usability and use opportunities, for example, by enabling users to stop viewing without needing special processing in a terminal and restart viewing in the same terminal as or a different terminal from that at the stopping.

A distribution system includes: means for communicating with terminals including a Graphical User Interface (GUI) provided to users; contents distribution means by multicast (multicast distribution means); means (unicast distribution means) for distributing contents from near a stop position by unicast; means (status management means) for managing user statuses of using users such as viewing, stopping contents by multicast distribution, and restarting viewing contents by unicast distribution; means (authentication information management means) for issuing authentication information provided to users at stopping or/and viewing (including viewing restart); and means (storage means) for managing authentication information and status information for each of users, and managing stop position information identifying a contents stop position at reception of a stop request. By this construction, contents are viewed by multicast distribution for a viewing request (first time) from a terminal, and if a stop request is issued at any point from the terminal during viewing, the request is approved, and when viewing a continuation of the contents is restarted after the stop, the contents are subjected to unicast distribution from near the previous stop position.

These means operate as follows. First, for arbitrary contents, when a terminal requests first viewing from the distribution system through the communication means of the distribution system, the status management means manages status information on a user identification (ID) as viewing of contents by multicast. The distribution system provides information (e.g., parameters necessary to identify a multicast distribution server) necessary to receive contents provided by the multicast distribution means to the terminal. At the same time, the authentication information management means generates authentication information (receipt information) necessary for a stop request (indication) for the terminal, and the distribution system provides it to the terminal.

For stopping, the terminal issues a stop request (indication) to the distribution system through the communication means of the distribution system together with the acquired receipt information. When the receipt information is receipt information that was generated and provided for the user ID by the distribution system, and when status managed in the storage means indicates viewing contents by multicast, the distribution system approves the stop, sets status information to stopping in the status management means, manages it in the storage means, manages stop position information at this time in the storage means, generates authentication information (restart password) necessary for a request to restart viewing in the authentication information management means, and provides it to the terminal. Even when such a stop request is issued from a specific user ID and approved in the distribution system, contents distributed by the multicast distribution means continue to be distributed.

When a specific user ID approved for stopping restarts viewing, the terminal issues a viewing restart request (indication) to the distribution system through the communication means of the distribution system together with the acquired restart password. When the restart password is one that was generated and provided for the terminal, and when the status managed in the storage means indicates stopping, the distribution system approves the restart, sets status information to restarting of contents by unicast in the status management means, manages it in the storage means, and provides information necessary for unicast reception to the terminal. At the same time, the authentication information means regenerates authentication information (receipt information) necessary for a re-stop request (indication), and the distribution system provides it to the terminal.

Thus, when the terminal accesses the unicast distribution means of the distribution system, the unicast distribution means uses the stop position information managed in the storage means to distribute contents from near the previous stop position to the terminal by unicast. The terms “near a stop position,” which relate to a contents playing position, mean contents playing from a position backed an arbitrary time from a point for which a stop request (indication) was made. However, whether a playing position is backed an arbitrary time or not does not matter; the both cases are permitted. Preferably, in terms of users' usability, playing should be restarted back from a stop point.

In this way, the distribution system allows users to view contents by multicast distribution for a viewing request (first time) from terminals to promote the use of multicast-based contents distribution that contributes to efficient use of communication networks, and allows the users to restart viewing a continuation of the contents from near a previous stop position by unicast distribution during viewing restart after the stopping.

In a stop position, the distribution system performs processing as follows. First, when the distribution system starts contents distribution by the multicast distribution means, it records the start point (time A) in advance. The record is managed for each of contents provided by the multicast distribution means, and contains, for example, time information or a chapter number by which an arbitrary point of the contents can be identified. Moreover, when the distribution system receives a stop request (indication) from a terminal through the communication means, and approves stopping, it records the point (stop approval point, point B). The point B usually is different for each of user IDs, and for each of stop request points. The stop position information may be any of the point B, the difference between the points A and B, an inversely computed value from the end point of the contents to the point B, and the like. The management of such stop positions is also true for stopping (re-stopping) during viewing restart by unicast distribution, except that a start point A for restarting is different for each of user IDs. When the distribution system starts distribution by the unicast distribution means that provides specific contents for a specific user ID, it manages the start point only for the specific user ID. This is the time point A. Moreover, a point (corresponding to point B) at which re-stopping is approved by a stop (re-stop) request that can occur only from the user ID is designated as a base point, and stop (re-stop) position information is generated based on the base point.

The distribution system integrates all such processing of stop positions, the status management means, the authentication information management means, and the storage means that manages information generated by these means as means and processing in the distribution system, whereby terminals may be different or identical between during viewing and during viewing restart after stopping. Users have only to remember authentication information (receipt information and restart password information) provided from the distribution system. For example, the users can use services of the distribution system simply by performing operations such as accessing sites existing in the Internet and the like, so that users' usability and use opportunities increase.

Information provided to terminals by the distribution system, except authentication information formed of a so-called character string such as receipt information and restart password, includes only the following two types of information: (1) information necessary to receive contents provided by the multicast distribution means, and (2) information necessary for unicast reception. Terminals have only to process these pieces of information, except contents playing processing. The two types of information are automatically processed by so-called generally available browsers and PCs, and, for example, are information uniquely identifying sites existing in the Internet and the like. Users basically need not be conscious of these types of information and processing for them (in some cases, these types of information may be required to be manually set for network setting for multicast reception or proxy setting, and may depend on Internet service provider (ISP) or the like in which users join). The authentication information, formed of a character string, is used for users' manual input when required, and does not require special processing such as communication encryption by use of a character string in terminals. Of course, such encryption processing may be performed in terms of an increase in security. Contents playing processing may be performed by so-called generally available playing software, and playing software suitable for the form of encrypting contents to be distributed has only to be installed in terminals.

In the distribution system, by having such a information package transmission means or/and functions of store-and-forward exchange type, forgetting the character string of authentication information, and the inconvenience of moving the character string of authentication information to a different terminal, copying it, and making a memo of it can be reduced, increasing users' usability.

### BRIEF DESCRIPTION OF THE DRAWINGS

FIG. 1 is a hardware block diagram of a network system;

FIG. 2 is a functional block diagram of a distribution system;

FIG. 3 is a sequence diagram among terminals, a service server, a multicast distribution server, a unicast distribution server, and a PDA;

FIG. 4A is a flowchart of a service server;

FIG. 4B is a detailed flowchart (1) of a service server;

FIG. 4C is a detailed flowchart (2) of a service server;

FIG. 5A is a drawing for explaining a membership information table;

FIG. 5B is a drawing for explaining a receipt information table;

FIG. 5C is a drawing for explaining a restart information table;

FIG. 5D is a drawing for explaining a user use condition table;

FIG. 5E is a drawing (1) for explaining a contents use condition table;

FIG. 6 is a hardware block diagram of a distribution system;

FIG. 7 is a hardware block diagram of terminals;

FIG. 8 is a flowchart of terminals for explaining first viewing and temporary stopping;

FIG. 9 is a flowchart of terminals for explaining viewing restart and re-stopping;

FIG. 10 is a drawing for explaining an entry prohibition point;

FIG. 11 is a functional block diagram of a distribution system;

FIG. 12 is a hardware block diagram of a distribution system;

FIG. 13 is a sequence diagram between a distribution system and plural terminals;

FIG. 14 is a detailed flowchart (3) of a service server;

FIG. 15 is a drawing (2) for explaining another contents use condition table; and

FIG. 16 is a drawing for explaining a forward prohibition section and a backward prohibition section.

### DETAILED DESCRIPTION OF THE PREFERRED EMBODIMENTS

Hereinafter, preferred embodiments of the present invention will be described using examples while referring to the accompanying drawings. The same reference numerals are assigned to substantially identical members, whose descriptions will not be repeated.

### First Embodiment

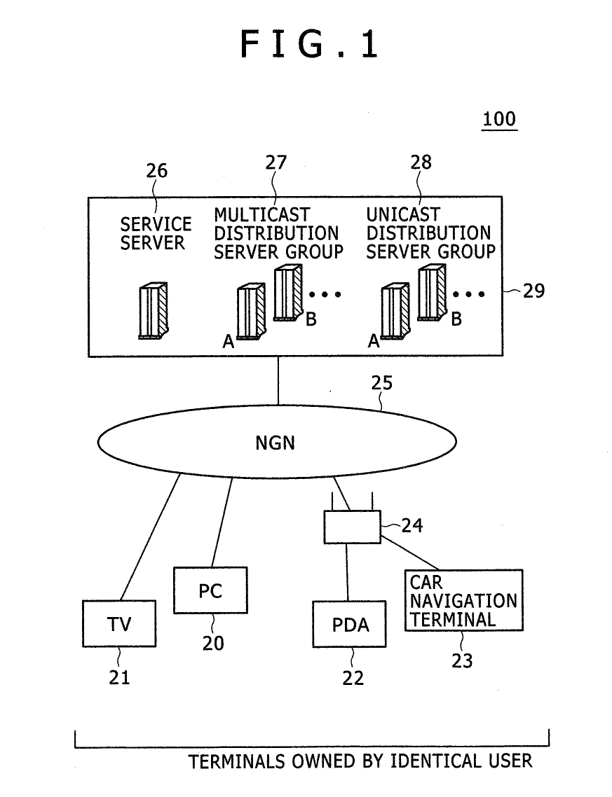

Referring to FIG. 1, the overall configuration of a network system will be described. FIG. 1 is a hardware block diagram of the network system. In this description, an NGN (Next Generation Network) 25 is used as a network capable of multicast and unicast. However, without being limited to the NGN 25, any communication networks capable of multicast transmission and unicast transmission are allowed.

A network system 100 includes a distribution system 29, a PC 20, a television (TV) 21, and an access point 24 that are connected to the NGN 25, and a PDA 22 and a car navigation terminal 23 that are connected to the access point 24.

Furthermore, the distribution system 29 includes a service server 26, plural multicast distribution servers 27, and plural unicast distribution servers 28. The PC 20, TV 21, PDA 22, and the car navigation terminal 23 are described as terminals of an identical user. Any of the PC 20, TV 21, PDA 22, and car navigation terminal 23 is a terminal.

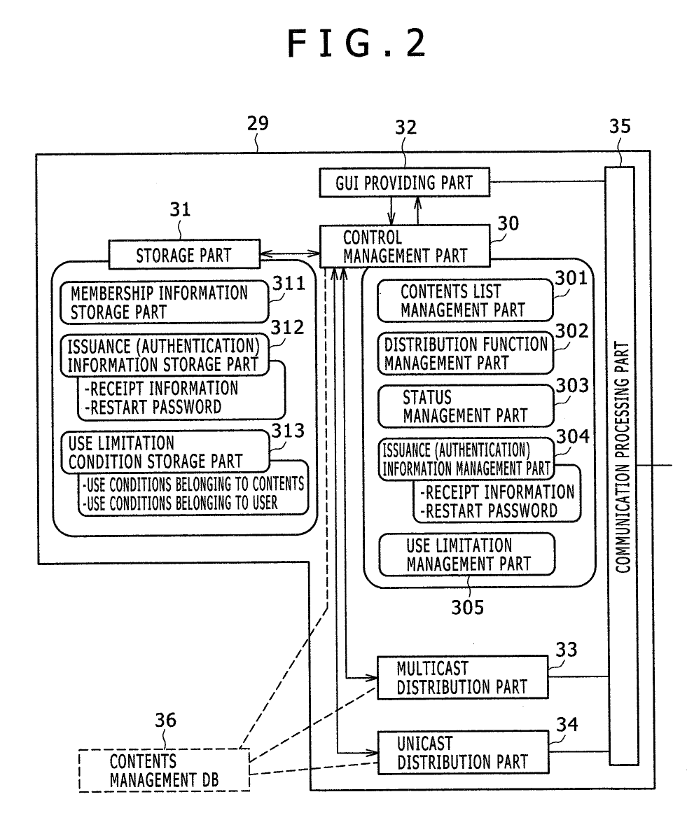

Referring to FIG. 2, the configuration of the distribution system is described. FIG. 2 is a functional block diagram of the distribution system. In FIG. 2, the distribution system 29 includes a control management part 30, a multicast distribution part 33, a unicast distribution part 34, a GUI providing part 32, a communication processing part 34, and a storage part 31. Furthermore, the control management part 30 includes a contents list management part 301, a distribution function management part 302, a status management part 303, an issuance (authentication) information management part 304, and a use limitation management part 305. The storage part 31 includes a membership information management part 311, an issuance (authentication) information storage part 312, and a use limitation condition storage part 313. The issuance (authentication) information management part 304 temporarily stores receipt information and restart password. The issuance (authentication) information storage part 312 stores receipt information and restart password. The use limitation condition storage part 313 stores use conditions pertaining to contents and use conditions pertaining to users.

The control management part 30 controls the multicast distribution part 33 to control multicast distribution through the communication processing part 35. The control management part 30 also controls the unicast distribution part 34 to control unicast distribution through the communication part 35. The control management part 30 further controls the GUI providing part 32 to control providing a GUI screen to users through the communication processing part 35.

A contents management database (DB) 36 connects with the control management part 30, the multicast distribution part 33, and the unicast distribution part 34. Information of contents stored in the contents management DB 36 is managed in the contents list management part 301 of the control management part 30. Contents themselves provided to the terminals in the multicast distribution part 33 are stored in the contents management DB 36. The multicast distribution part 33, under control of the control management part 30, distributes arbitrary contents at an arbitrary time from the beginning of contents to plural users who are subject to multicast reception.

On the other hand, contents themselves provided to the terminals in the unicast distribution part 34 are also stored in the contents management DB 36. The unicast distribution part 34, under control of the control management part 30, provides unicast distribution to a specific user from a stop position (stop neighborhood position) of contents for the user.

Although the contents management DB 36 is placed outside the distribution system 29, it may be included in the distribution system 29. In this sense, a block and connection lines are shown by dashed lines.

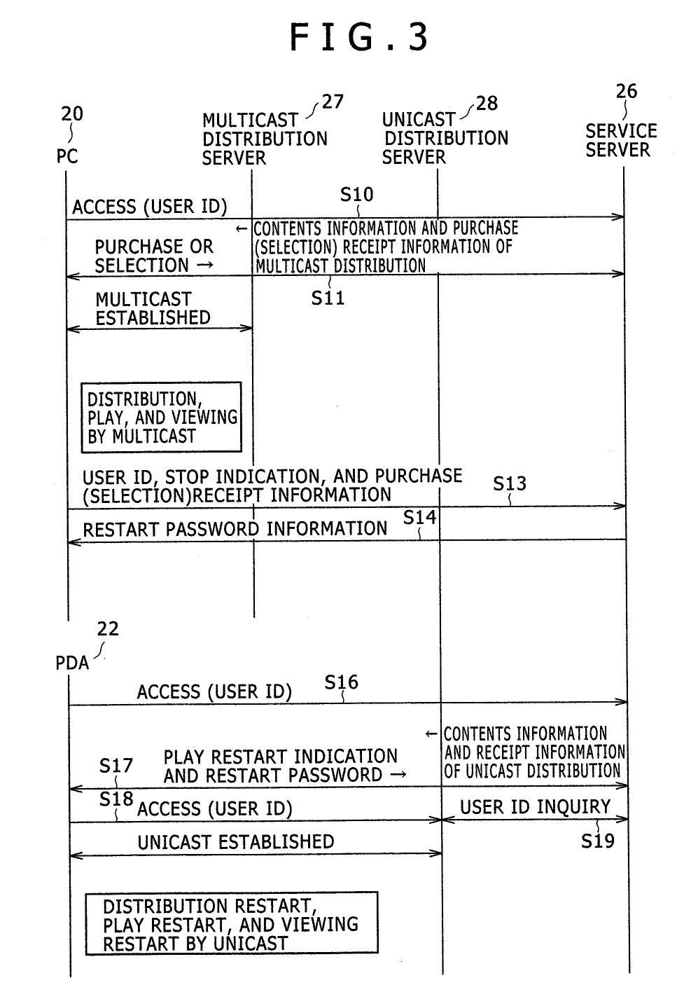

Referring to FIG. 3, a description is made of communication control among the terminals, service server, multicast distribution server, and unicast distribution server. FIG. 3 is a sequence diagram among the terminals, service server, multicast distribution server, and unicast distribution server. In sequence diagrams and flowcharts that follow, including FIG. 3, sequences and steps are represented in a lump to a degree easily understandable to those skilled in the art.

In FIG. 3, the PC 20 uses a browser to access the server 26, and transmits a user ID (S10). In response to the access, the service server 26 lets the PC 20 display a menu screen of multicast distribution. The user of the PC 20 selects contents to be purchased. By the user's operations, the PC 20 transmits purchase (selection) information to the service server 26, which replies purchase (selection) receipt information and contents information (e.g., delivery server address information of contents provided by multicast distribution) of multicast distribution to the PC 20 (S11). By the above, multicast communication is established between the PC 20 and the multicast distribution server 27. As a result, the user of the PC 20 plays contents distributed by multicast in the PC 20 for viewing.

The user of the PC 20 might operate the PC 20 to stop the viewing of contents distributed by multicast. The PC 20 transmits a user ID, stop indication, and purchase (selection) receipt information to the service server 26 (S13). At this time, the service server 26 provides a screen prompting for input of the purchase (selection) receipt information of Step 11 to the PC 20 that has made access with stop indication. As a result, by a user operation on the purchase (selection) receipt information acquired in Step 11, the PC 20 transmits the purchase (selection) receipt information to the service server 26.

As a result of the stop operation in Step 13, when approving the viewing stop, the service server 26 provides restart password information to the PC 20, which receives it and presents the information to the user (S14). By confirming the password information, the user of the PC 20 performs the operation of stopping contents viewing, which is the operation of freeing multicast communication. Of course, the terminal frees and terminates multicast communication when the user performs user activities such as turning off power to the viewing terminal, terminating play software of the viewing terminal, or terminating a browser or software of the viewing terminal for network access.

Thus, even when a stop indication is issued from a specific terminal, the distribution system 29 does not stop contents distribution by multicast as long as other users or other terminals receive.

The user of the PC 20 is also the user of the PDA 22. The user of the PDA 22 might restart the viewing of the stopped contents. The PDA 22 uses a browser to access the service server 26 and transmits a user ID (S16). In response to the access, the service server 26 lets the PDA 22 display a menu screen. The PDA 22 transmits play restart indication and a restart password to the service server 26. The service server 26 transmits receipt information of the play restart indication and contents information (e.g., delivery server address information of restart contents provided by unicast distribution) of unicast distribution to the PDA 22 (S17).

As a result, the PDA 22 accesses the unicast distribution server 28 to transmit the user ID (S18). The unicast distribution server 28 and the service server 26 that have received the user ID query and reply the user ID between them to authenticate the user ID (S19). By the above operations, unicast communication is established between the PDA 22 and the unicast distribution server 28. As a result, the user of the PDA 22 plays and views in the PDA 22 the stopped contents distributed by unicast.

Between Step 11 and Step 13, the session between the PC 20 and the service server 26 may continue to be established.

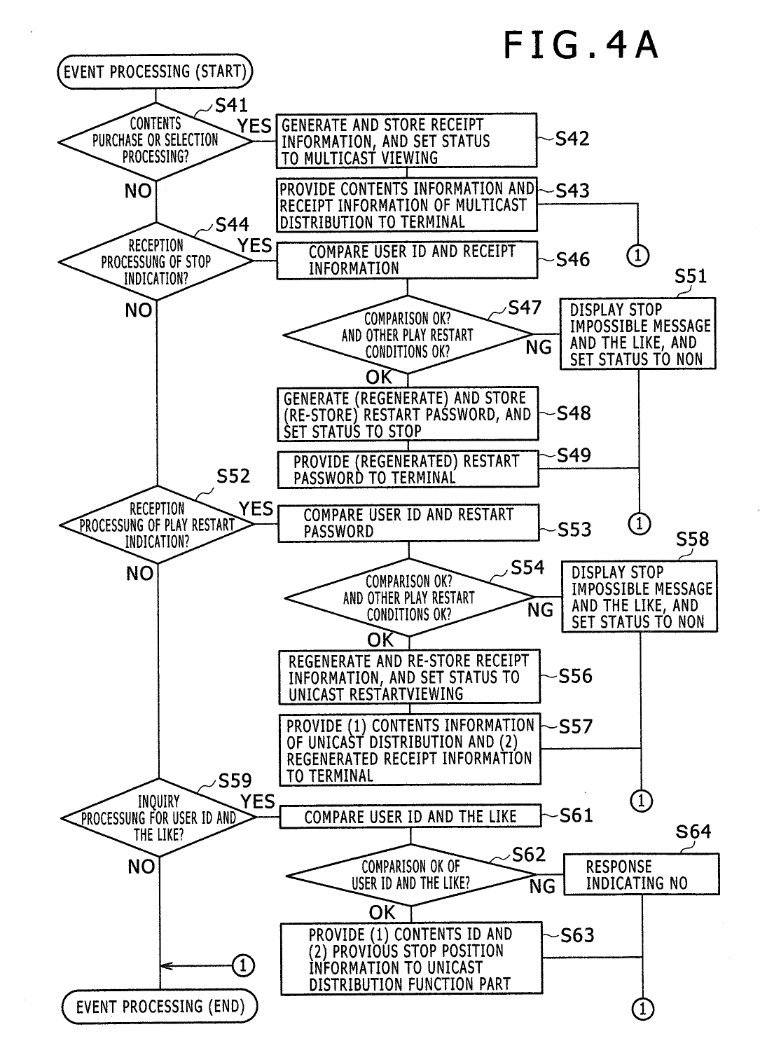

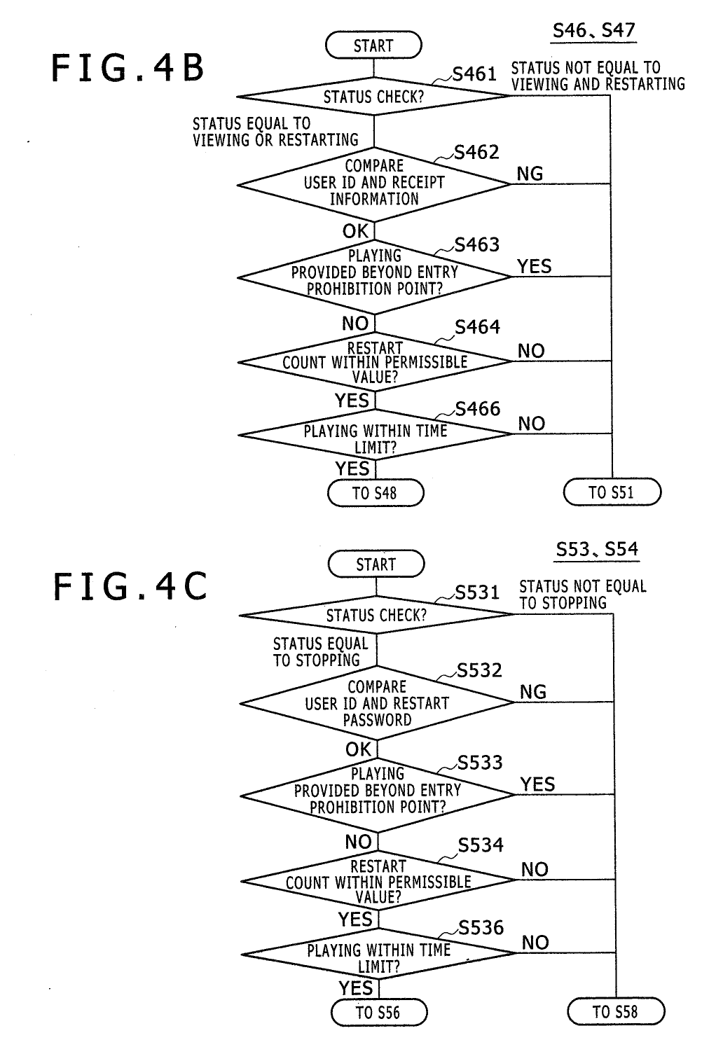

Referring to FIG. 4, a description is made of the processing flow of the service server that has accepted access. FIG. 4 are flowcharts of the service server. In FIG. 4A, the service server 26 starts event processing and determines whether the access is contents purchase or selection processing (S41). For YES, the service server 26 generates receipt information, stores it in a receipt information table, and sets status of the receipt information table to multicast viewing (S42). The service server 26 provides contents information of multicast distribution to the terminal, provides the receipt information to the terminal in response to purchase or selection information from the terminal (S43), and terminates.

For NO in Step 41, the service server 26 determines whether the access is stop indication or reception processing (S44). For YES, the service server 26 compares a user ID and the receipt information (S46). The service server 26 determines whether the comparison result and other play restart conditions are OK (S47). For OK, the service server 26 generates a restart password, stores it in a restart information table, and changes status of the receipt information table to stopping (S48). The service server 26 provides the restart password to the terminal (S49), and terminates. On the other hand, for NG in Step 47, the service server 26 displays a stopping prohibition message (provides it to the terminal), sets the status of the receipt information table to Non (S51), and terminates.

For NO in Step 44, the service server 26 determines whether the access is processing for accepting a play restart indication (S52). For YES, it compares the user ID and the restart password (S53). The service server 26 determines whether the comparison is OK and other play restart conditions are OK (S54). For OK, the service server 26 regenerates receipt information, re-stores it in the receipt information table, and sets the status of the receipt information table to unicast viewing (S57). The service server 26 provides contents information of unicast distribution and the regenerated receipt information to the terminal (S57), and terminates. On the other hand, for NG in Step 54, the service server 26 displays a stopping prohibition message (provides it to the terminal), sets the status of the receipt information table to Non (S58), and terminates.

For NO in Step 52, the service server 26 determines whether the access is processing for inquiring about a user ID (S59). For YES, the service server 26 performs comparison on the user ID (S61). The service server 26 determines whether the comparison result is OK (S62). For OK, the service server 26 provides a contents ID and stop position information to the unicast distribution server 28 (S63), and terminates. On the other hand, for NG in Step 62, the service server 26 replies a response indicating NO to the unicast distribution server (S64), and terminates.

Referring to FIGS. 4B and 4C, a detailed description is made of Steps 46, 47, 53, and 54 in FIG. 4A. In FIG. 4B, the service server 26 checks the status (S461). When the status is other than viewing or restart, it transitions to Step 51. When the status indicates viewing or restart in Step 461, the service server 26 compares the user ID and receipt information (S462). When the comparison is NG, the service server 26 transitions to Step 51. For OK in Step 462, the service server 26 determines whether playing has been provided beyond an entry prohibition point (S463). For YES, the service server 26 transitions to Step 51. For NO in Step 463, the service server 26 determines whether a restart count is within the range of permissible values (S464). For NO, the service server 26 transitions to Step 51. For YES in Step 464, the service server 26 determines whether playing is within a permissible time limit (S466). For NO, it transitions to Step 51. For YES in Step 466, the service server 26 transitions to Step 48.

In FIG. 4C, the service server 26 checks the status (S531). When the status is other than stopping, the service server 26 transitions to Step 58. When the status indicates stopping in Step 531, the service server 26 compares the user ID and restart password (S532). When the comparison is NG, the service server 26 transitions to Step 58. For OK in Step 532, the service server 26 determines whether playing has been provided beyond an entry prohibition point (S533). For YES, the service server 26 transitions to Step 58. For NO in Step 533, the service server 26 determines whether a restart count is within the range of permissible values (S534). For NO, the service server 26 transitions to Step 58. For YES in Step 534, the service server 26 determines whether playing is within a permissible time limit (S536). For NO, the service server 26 transitions to Step 58. For YES in Step 536, the service server 26 transitions to Step 48.

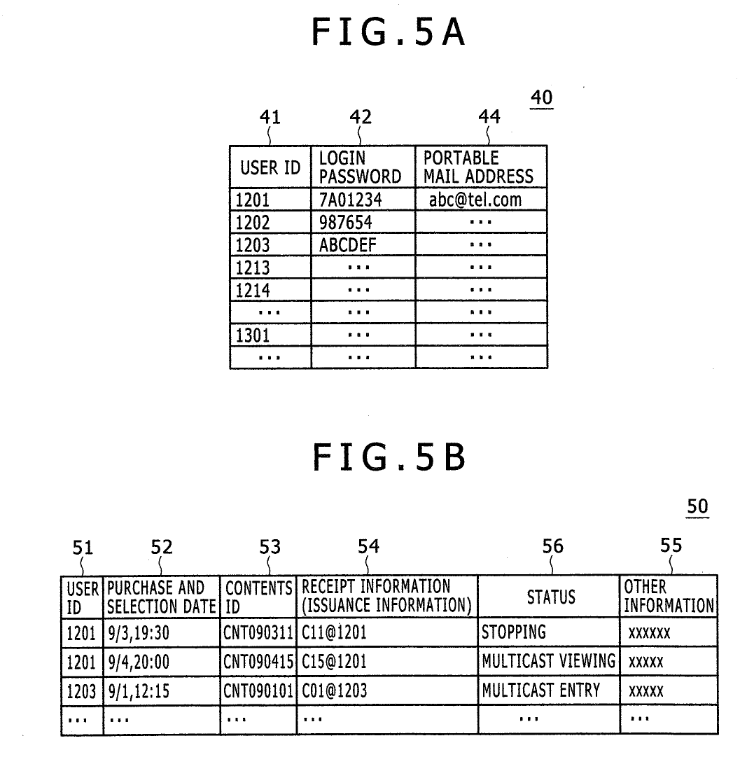

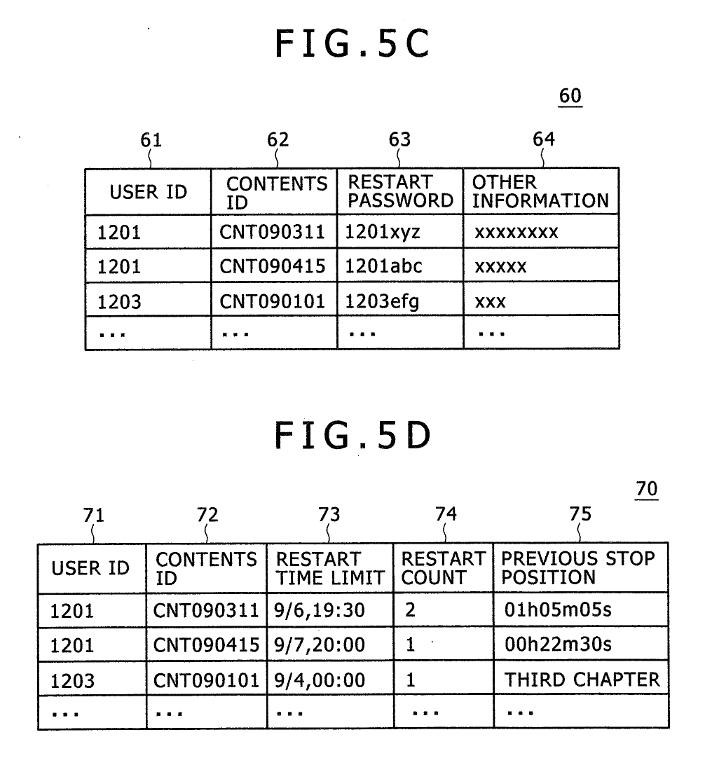

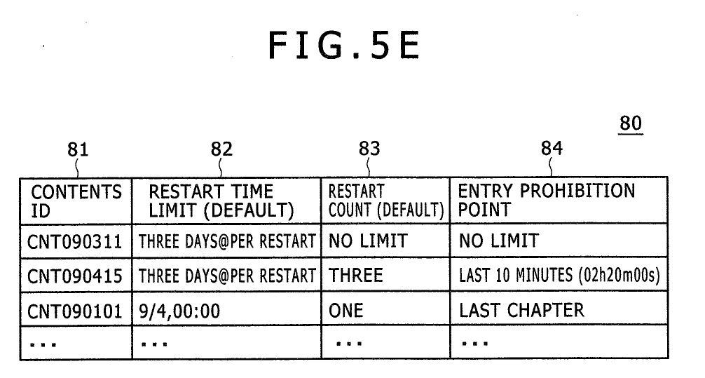

Referring to FIG. 5, various tables held in the storage part of the distribution system are described. FIG. 5A is a drawing for explaining a membership information table. FIG. 5B is a drawing for explaining a receipt information table. FIG. 5C is a drawing for explaining a restart information table. FIG. 5D is a drawing for explaining a user use condition table. FIG. 5E is a drawing for explaining a contents use condition table.

In FIG. 5A, the membership information table 40 includes a user ID 41, a login password 42, a status 43, and a portable mail address 44. The user ID 41 stores user IDs specific to individual users. The login password 42 stores login passwords specific to individual users. The portable mail address 44 stores portable mail addresses specific to individual users as required.

In FIG. 5B, the receipt information table 50 includes a user ID 51, a purchase/selection date 52, a contents ID 53, receipt information 54, a status 56, and other information 55. The user ID 51 stores user IDs specific to individual users. The purchase/selection date 52 stores purchase/selection dates. The contents ID 53 stores the IDs of purchased contents.

The status 56 stores a current status of contents purchased (selected) by users. Of course, records managed in the receipt information table are managed within a contract validity term (e.g., a month-by-month contract term in the case of a monthly contract) determined between users and the service server. The receipt information table 50 contains two records of a user ID 1201. This means that two contents are purchased and can be viewed.

In FIG. 5C, the restart information table 60 includes a user ID 61, a contents ID 62, a restart password 63, and other information 64. The user ID 61 stores user IDs specific to individual users. The contents ID 62 stores the IDs of stopped contents. The restart password 63 stores restart passwords provided (generated for issuance) to users from the service server 26 which are used by the users at restart.

In FIG. 5D, the user use condition table 70 includes a user ID 71, a contents ID 72, a restart time limit 73, a restart count 74, and a previous stop position 75. The user ID 71 stores user IDs specific to individual users. The contents ID 72 stores the IDs of purchased contents. The restart time limit 73 stores the restart time limits of purchased contents. The restart count 74 stores the restart counts of purchased contents. The previous stop position 75 stores the stop positions of stopped contents.

In FIG. 5E, the contents use condition table 80 includes a contents ID 81, a restart time limit 82, a restart count 83, and an entry prohibition point 84. The contents ID 81 stores the IDs of held contents. The restart time limits 82 stores the restart time limits (default values) of contents. The restart count 83 stores the restart counts (default values) of contents. The entry prohibition point 84 stores the prohibition points (default values) of stop entries of relevant contents.

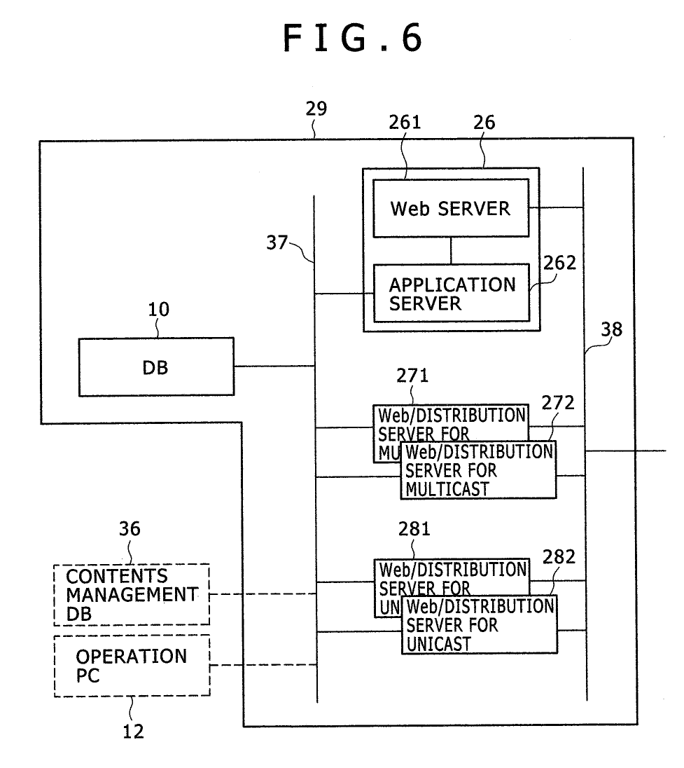

Referring to FIG. 6, the configuration of the distribution system is described again. FIG. 6 is a hardware block diagram of the distribution system. In FIG. 6, the distribution system 29 includes a service server 26 connected to both a first bus 38 and a second bus 37, two multicast Web/distribution servers 271 and 272, two unicast Web/distribution servers 281 and 282, and a database (shown as DB) 10 connected to the second bus 37.

A contents information management DB 38 connected to the second bus 37 and an operation terminal 12 may be included in the distribution system 29.

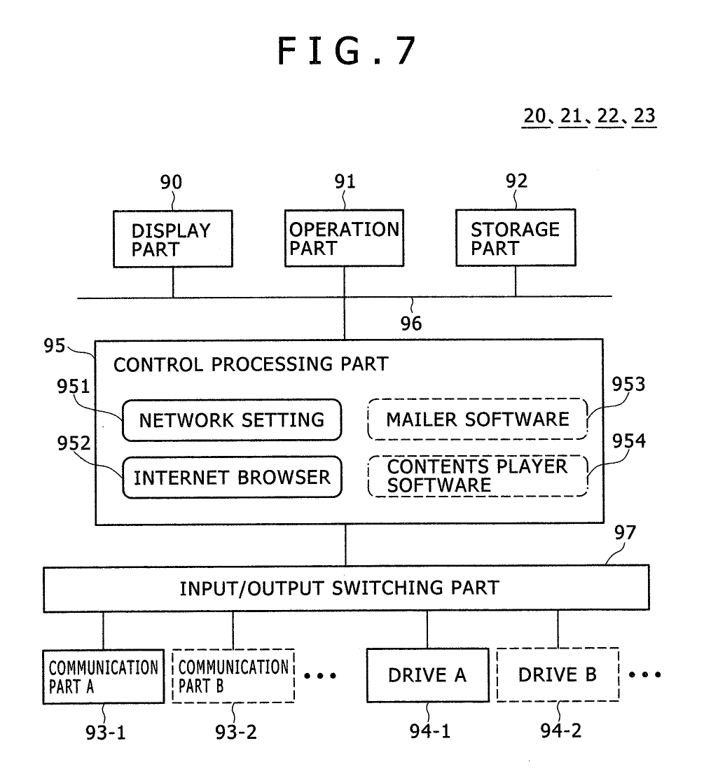

Referring to FIG. 7, the configuration of the terminals is described. FIG. 7 is a hardware block diagram of terminals. The terminals 20, 21, 22, and 23 include a control processing part 95, a display part 90, an operation part 91, and a storage part 92 that are connected to a bus 96, an input/output switching part 97 connected to the control processing part 95, and a communication part 93-1 and an external storage device (drive) 94-1 that are connected to the input/output switching part 97. The control processing part 95 functions as a network setting part 951, an Internet browser 952, and contents player software 954 by executing programs.

The control processing part 95 may function as mailer software 953 by executing programs. Furthermore, it may include a communication part 932-2 and a drive 94-2.

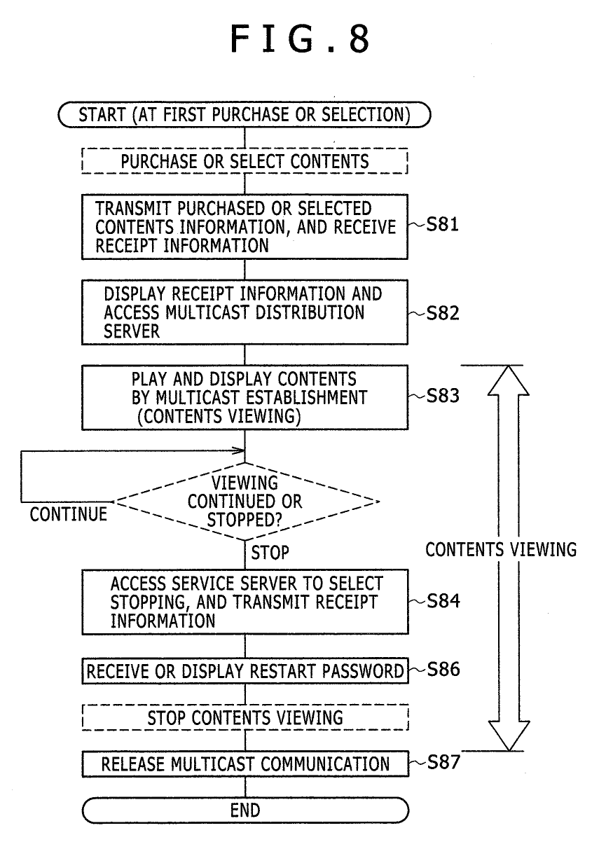

Referring to FIG. 8, the operation of the terminals for first viewing (multicast reception/play) and temporary stopping of viewing is described. FIG. 8 is a flowchart of the terminals for explaining first viewing and temporary stopping. In FIG. 8, a terminal's user selects contents and decides purchase. By the purchase (selection), the terminal receives the purchased or selected contents information (e.g., the delivery server address information of restart contents provided by multicast distribution) from the service server, and receives receipt information, which is display information to the user (S81). The terminal displays the received receipt information and uses the received contents information to access a specified multicast server (S82). The terminal receives contents provided by multicast distribution to play and display them (S83).

The terminal's user might view the contents and decide stopping. When accessing the service server to select stopping (transmission of a stop indication by the terminal), the user is prompted to input receipt information from the service server, and inputs the receipt information in Step 81 (transmission of receipt information by the terminal) (S84). As a result, when the stop indication is approved in Step 84, the terminal receives a restart password from the service server and displays it (S86). The terminal's user performs the operation of stopping contents viewing, which is the operation of release multicast communication. The terminal releases multicast communication (S87), and terminates. Between Step 83 and 87, the terminal's user can view contents by multicast distribution.

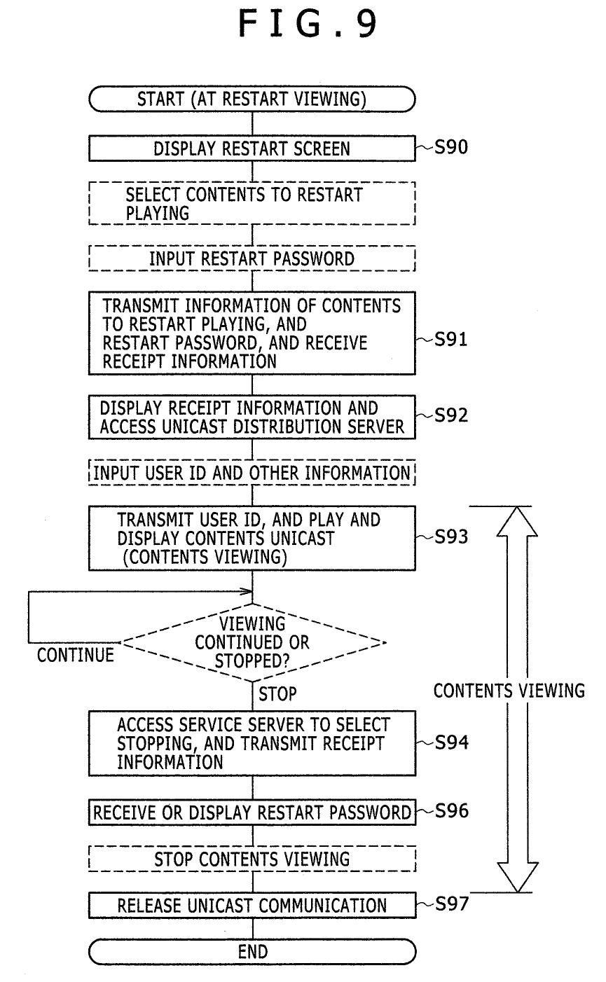

Referring to FIG. 9, the operation of the terminal for restart viewing and re-stopping is described. FIG. 9 is a flowchart of terminals for explaining viewing restart and re-stopping. In FIG. 9, a terminal's user uses a browser to access the service server, and the terminal displays a restart screen (S90). The terminal's user selects contents for restart of playing, and operates the terminal to input a restart password. The terminal transmits contents information for restart of playing and the restart password to the service server, receives the contents information for play and restart (e.g., the delivery server address of restart contents provided by unicast distribution) from the service server, and receives receipt information, which is display information to the user (S91). The terminal displays the received receipt information, and uses the received contents information to access a specified unicast distribution server (S92). The user operates the terminal to input a user ID and the like. The terminal transmits the user ID and the like, and receives the stopped contents by unicast distribution to play and display it (S93).

The terminal's user might view the contents and further decide stopping. When accessing the service server and further selecting re-stop (transmission of a stop indication by the terminal), the user is prompted to input receipt information from the service server, and inputs the receipt information in Step 91 (transmission of receipt information by the terminal) (S94). As a result, when the stop (re-stop) indication is approved in the service server, the terminal receives a restart password from the service server and displays it (S96). The terminal's user performs the operation of stopping contents viewing, which is the operation of release unicast communication. The terminal releases unicast communication (S97), and terminates. Between Step 93 and 97, the terminal's user can view the stopped contents by unicast distribution.

The restart screen in Step 90 displays a viewing restart position, residual restart count, and restart time limit in contents viewable to the relevant user. This prompts the user to view contents with a restart count of one to the end. Also, the user tries to preferentially view contents of nearing playing time limits.

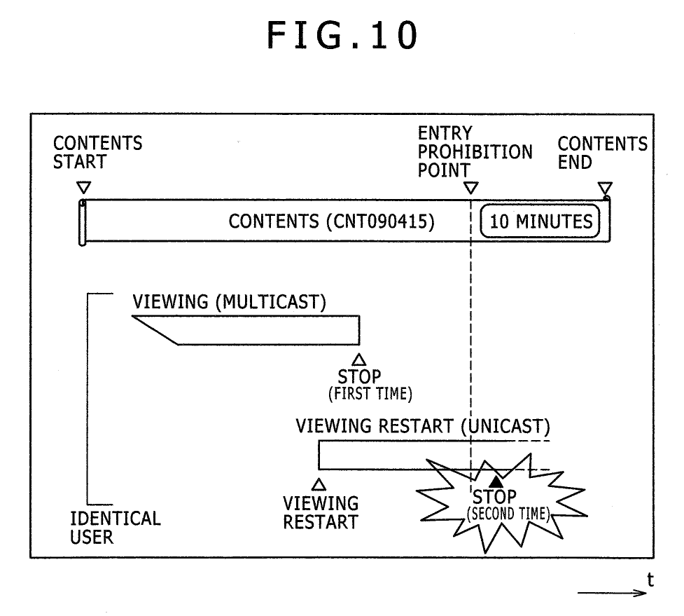

Referring to FIG. 10, the entry prohibition points described in FIG. 5E are described. FIG. 10 is a drawing for explaining an entry prohibition point. In FIG. 10, the lateral axis is a time axis of contents of a contents ID “CNT090415.” The entry prohibition point 84 of the contents ID “CNT090415” in FIG. 5E indicates remaining time of 10 minutes (02 h 20 m 00 s).

An identical user temporarily stops multicast-based viewing of the contents of contents ID “CNT090415,” then restarts unicast-based viewing from a little before a stop point. Furthermore, the user might try second stopping beyond an entry prohibition point. The distribution system 29 determines that the stopping is not permitted because of a stopping action in an entry prohibition section, as described in FIG. 4. Of course, the user can stop the viewing as shown in the dashed lines by turning off the power to the viewing terminal. However, restart is disabled. Thus, providing an entry prohibition point helps prevent only a climax of movie contents and the like from being viewed by a large number of persons.

### Second Embodiment

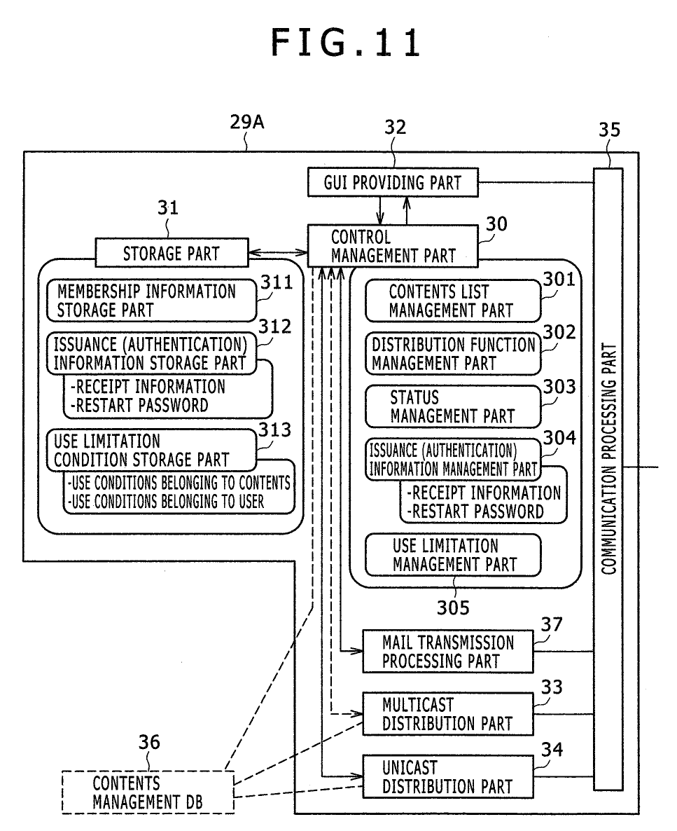

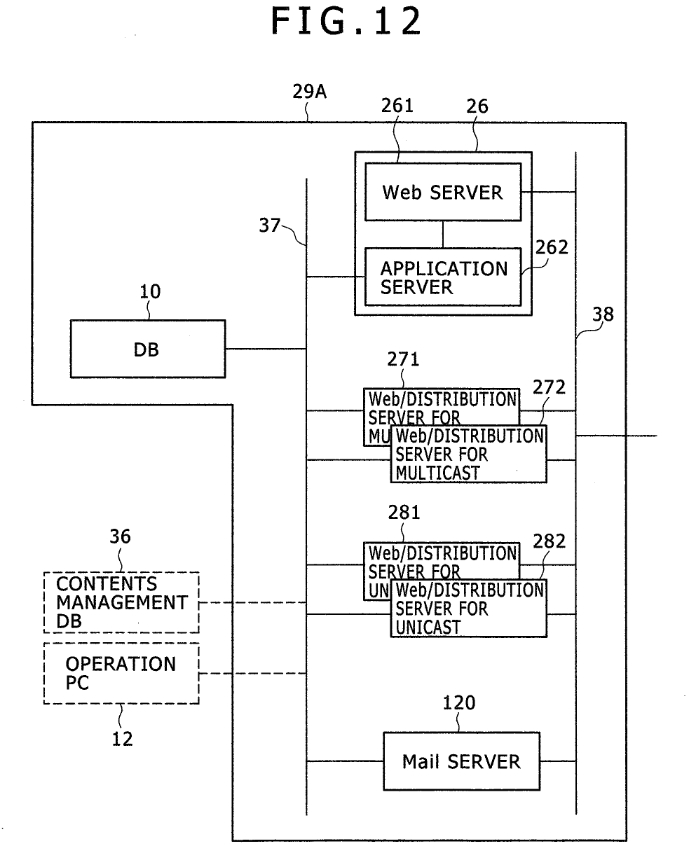

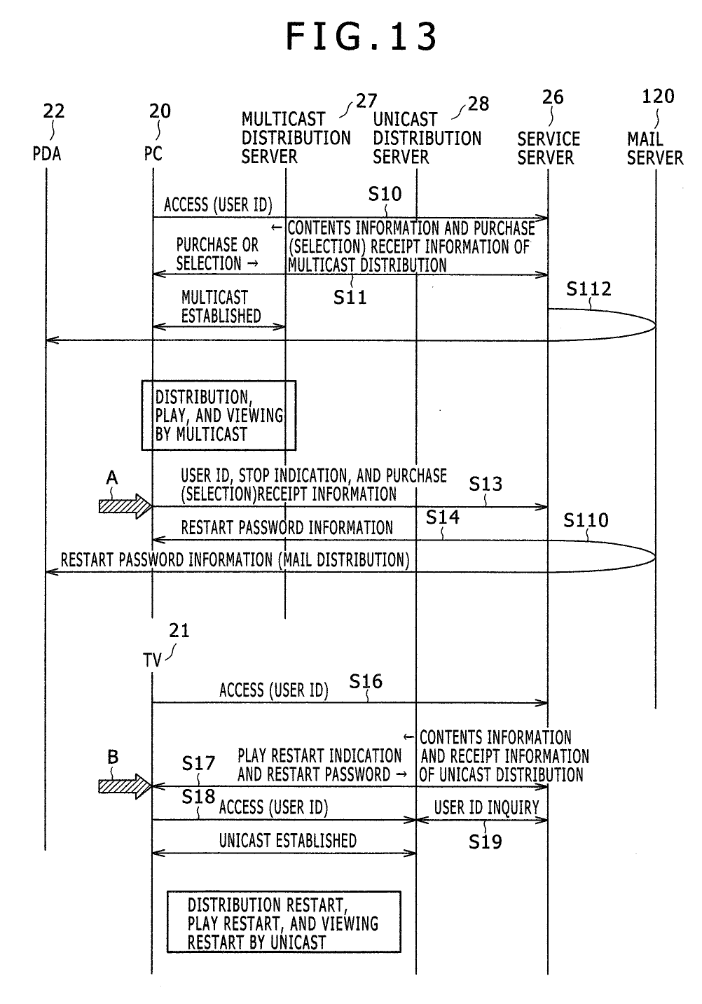

Referring to FIGS. 11 to 13, a second embodiment is described. FIG. 11 is a functional block diagram of the distribution system. FIG. 12 is a hardware block diagram of the distribution system. FIG. 13 is a sequence diagram between the distribution system and plural terminals.

In FIG. 11, a distribution system 29A is different from the distribution system 29 described in FIG. 6 only in that a mail server 120 is added. The mail server 120 transmits receipt information, restart password, and the like to a portable mail address 44 of FIG. 5A that corresponds to the user. The user can refer to the receipt information, restart password, and the like by mail received by a portable phone or PDA.

In FIG. 12, the distribution system 29A is different from the distribution system 29 described in FIG. 2 only in that a mail transmission processing part 37 is added. The mail transmission processing part 37 transmits receipt information, restart password, and the like to a portable mail address 44 of FIG. 5A that corresponds to the user. The user can refer to the receipt information, restart password, and the like by mail received by a portable phone or a PDA.

In FIG. 13, sequences of connection with the distribution system, stopping, and reconnection is the same as those in FIG. 3, except that a reconnection destination is changed from the PDA 22 to the TV 21. Therefore, the same sequences as in FIG. 3 are assigned the same sequence numbers and omitted from their descriptions. The service server 26 transmits receipt information to the PC 20 in the sequence 11, and further transmits by mail the receipt information the PDA 22 through the mail server 120 (S112). The receipt information received in the PDA 22 is referred to by the user and used during the input of stopped data shown by the arrow A.

The service server 26 transmits a restart password to the PC 20 in a sequence 14, and further transmits by mail the restart password to the PDA 22 through the mail server 120 (S110). The restart password received in the PDA 22 is referred to by the user and used during the input of restart data shown by the arrow B.

### Third Embodiment

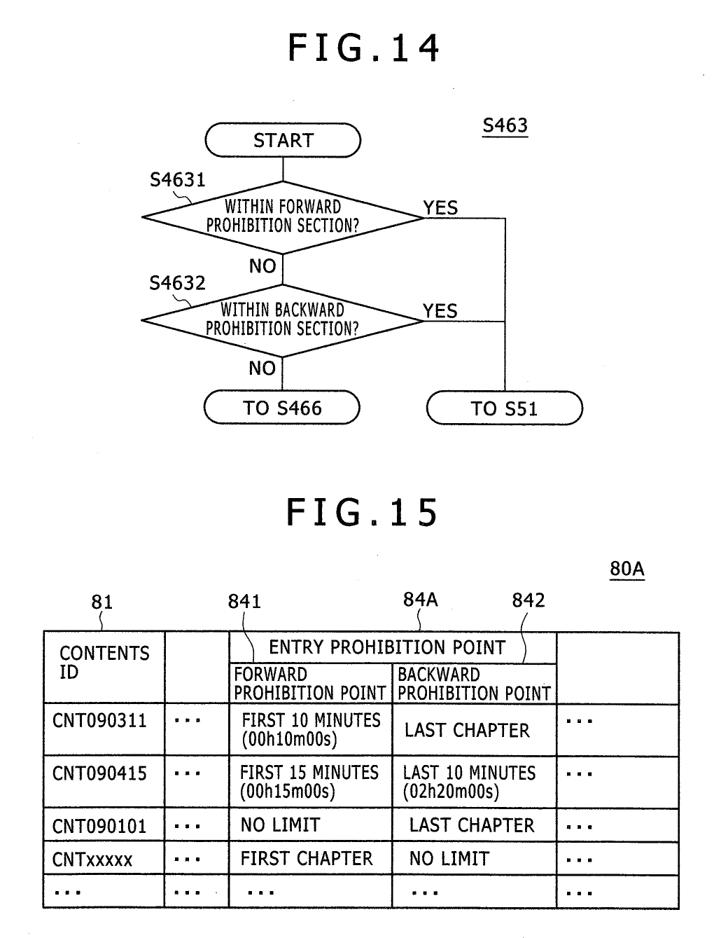

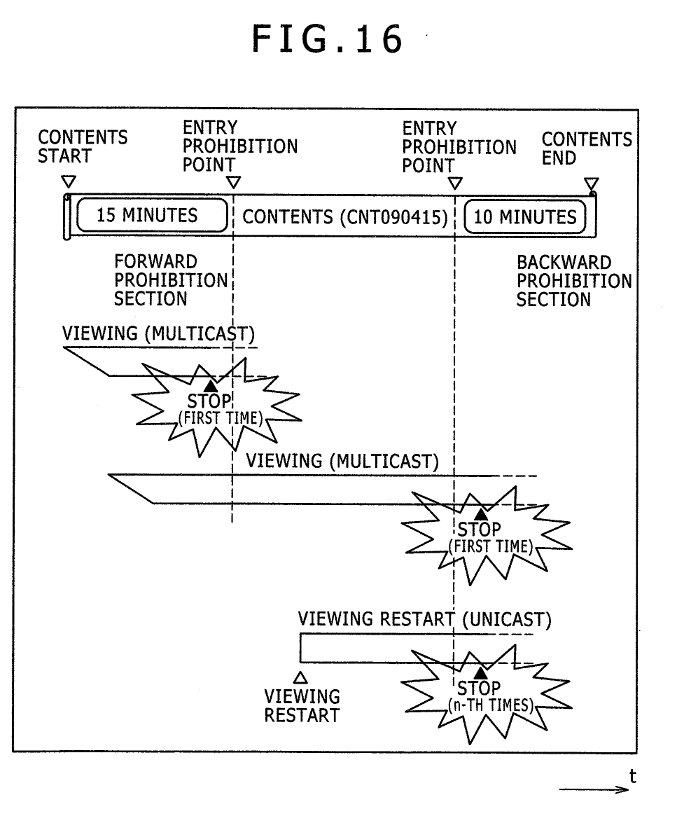

Referring to FIGS. 14 to 16, a third embodiment is described. The third embodiment is a variant of the first embodiment, and is also applicable to the second embodiment. FIG. 14 is a detailed flowchart of the service server. FIG. 15 is a drawing for explaining another contents use condition table. FIG. 16 is a drawing for explaining a forward prohibition section and a backward prohibition section.

In FIG. 14, Step 463 in FIG. 4B is divided into determination on a forward prohibition section (S4631) and determination on a backward prohibition section (S4632). For NO in both the determinations, the service server 26 transitions to Step 466. For YES in at least one of the determinations, it transitions to Step 51 of FIG. 4A.

In FIG. 15, a contents use condition table 80A is different from the contents use condition table 80 in FIG. 5E in that it has forward prohibition points 841 and backward prohibition points 842 as entry prohibition points 84A. In contrast to this, the contents use condition table 80 has only backward prohibition points as entry prohibition points 84. The contents of contents ID “CNT090415” are prohibited from being stopped for the first 15 minutes and for the last 10 minutes. Since stopping before a forward prohibition point would disable restart, an administrator of the distribution system has the merit of demanding a fee twice. Multicast is lower in transmission costs per user than unicast.

Referring to FIG. 16, a forward prohibition section and a backward prohibition section are described. In FIG. 16, the lateral axis is a time axis of contents of a contents ID “CNT090415.” The user might stop the contents of contents ID “CNT090415” 10 minutes after starting multicast-based viewing. The distribution system 29 or 29A, as described in FIGS. 4 and 14, determines that the stopping is not permitted because of a stopping action in a forward prohibition section. Of course, the user can stop the viewing as shown in the dashed lines by turning off the power to the viewing terminal. However, restart is disabled.

The user might stop the contents of contents ID “CNT090415” two hours and 25 minutes after starting multicast-based viewing. The distribution system 29 or 29A, as described in FIGS. 4 and 14, determines that the stopping is not permitted because of a stopping action in a backward prohibition section. Of course, the user can stop the viewing as shown in the dashed lines by turning off the power to the viewing terminal. However, restart is disabled.

Furthermore, the user might stop the contents of contents ID “CNT090415” for the duration of the last 10 minutes after starting unicast-based viewing. The distribution system 29 or 29A, as described in FIGS. 4 and 14, determines that the stopping is not permitted because of a stopping action in a backward prohibition section. Of course, the user can stop the viewing as shown in the dashed lines by turning off the power to the viewing terminal. However, restart is disabled.

Thus, providing a backward prohibition point helps prevent only a climax of movie contents and the like from being viewed by a large number of persons. Also, providing a forward prohibition point helps induce users to view contents by multicast.

According to the above embodiments, in a distribution system that distributes contents such as videos and sounds through a network, the use of multicast-based contents distribution that contributes to efficient use of the communication network is promoted. Moreover, terminals can stop viewing without needing special processing. Still, at restart time, restarting is enabled in the same terminal as that at stop time or a different terminal.

What is claimed is:

1. A distribution system that distributes contents data to terminals, comprising the steps of:
for a start request from one the terminals, transmitting first contents data by multicast distribution;
for a stop request from the one in the course of transmitting the first contents data, stopping transmitting the first contents data; and
for a restart request from one the terminals, transmitting the first contents data by unicast distribution from a stop position when the stop request was received, or from near the stop position.

2. The distribution system according to claim 1, in the course of data transmission by the unicast distribution, for a stop request from the one under data transmission, stopping transmitting the first contents data.

3. The distribution system according to claim 1, further comprising the steps of:
setting a section from a point forward of an end point of contents to the end point as an entry prohibition section to prohibit stopping, for each of contents; and
in the course of transmitting the first contents data by multicast distribution or unicast distribution, for a stop request from the one under data transmission, rejecting to stop transmitting the first contents data in the entry prohibition section.

4. The distribution system according to claim 1, comprising the steps of:
setting a section from a start point of contents to a point backward of the start point as an entry prohibition section to prohibit stopping, for each of contents; and
in the course of transmitting the first contents data by multicast distribution, for a stop request from the one under data transmission, rejecting to stop transmitting the first contents data in the entry prohibition section.

5. The distribution system according to claim 1, comprising the steps of:
setting a contents restart count for each of contents;
upon receiving the restart request, determining whether the restart count is exceeded; and
upon exceeding the restart count, rejecting to stop transmitting the first contents data.

6. The distribution system according to claim 1, comprising the steps of:
setting a contents restart time limit for each of contents;
upon receiving the restart request, determining whether the restart time limit is exceeded; and
upon exceeding the restart time limit, rejecting to stop transmitting the first contents data.

7. The distribution system according to claim 1, when receiving the restart request, transmitting information indicating from which position the first contents are to be transmitted, to the terminal.

8. The distribution system according to claim 1, when receiving the restart request, transmitting restartable count information and restart time limit information of the first contents data to the one.

9. A distribution system that distributes contents data to terminals, comprising:
a service server which receives purchase information, stop indication information and restart password information from one of the terminals, transmits contents information or the restart password information to the one, and exchanges an inquiry with a unicast distribution server;
a multicast distribution server which distributes contents from the beginning to the one; and
said unicast distribution server which distributes said contents from around a stop position to one of the terminals.
